(19) United States
(12) Patent Application Publication
(10) Pub. No.: US 2022/0375355 A1
(43) Pub. Date: Nov. 24, 2022

(54) GENERATION METHOD OF A SEQUENCE OF AIRCRAFT ARRIVAL TIMES AT THE IAF

(71) Applicants: GIOVANNI BRAMBILLA, DRESANO (MI) (IT); Monica SCOPACASA, DRESANO (MI) (IT)

(72) Inventors: GIOVANNI BRAMBILLA, DRESANO (MI) (IT); Monica SCOPACASA, DRESANO (MI) (IT)

(21) Appl. No.: 17/783,896

(22) PCT Filed: Dec. 10, 2020
(86) PCT No.: PCT/IB2020/061741

§ 371 Date: Jun. 9, 2022

(30) Foreign Application Priority Data
Dec. 13, 2019 (IT) 102019000023916

(51) Int. Cl. G08G 5/00; G08G 5/02; H04W 4/42

(52) U.S. Cl. CPC G08G 5/0043; G08G 5/0013; G08G 5/025; H04W 4/42

(57) ABSTRACT

A generation method of a sequence (Ot1, OT2 . . . 0Tn) of arrival times at the IAF of a plurality of aircrafts (A1, A2 . . . An) which must arrive at a specific airport (IC) is described, said method comprising:—Establishing (B1, B2 . . . Bn) at least one first (LT1, LT2 . . . LTn) and a second (ET1, ET2 . . . ETn) estimate arrival times at the IAF as a function of the minimum (Vmin1, Vmin2 . . . Vminn) and the maximum (Vmax1, Vmax2 . . . Vmaxn) cruise speed of each aircraft and as a function of the cruise altitude (H1, H2 . . . Hn) and the descendent angle (ANG1, ANG2 . . . ANGn) of the aircraft by means of a first device (1) arranged inside each aircraft of the plurality of aircrafts;—Sending (C1, C2 . . . Cn) said first and second estimate arrival times at the IAF of each aircraft from the first device (1) arranged inside each aircraft of the plurality of aircrafts to a second device (2) arranged inside said specific airport (IC) when each aircraft of the plurality of aircraft (A1 . . . An) is in flight towards the specific airport (IC);—Defining (F2) a sequence (BS, NS) of arrival times at the IAF for each single aircraft of said plurality of aircrafts as a function of said first and second estimate arrival times at the IAF and at least the wake turbulence data (WT1, WT2 . . . WTn) of each aircraft and the airport receptivity (RA) of said specific airport (IC), said defining step comprising:—Extracting (F21, F41) from a database (DWT) said wake turbulence data (WT1, WT2 . . . WTn) of the plurality of aircrafts (A1, A2 . . . An); Grouping (F22, F42) the aircrafts having the same wake turbulence category and the arrival time at the IAF of which is inside a time window comprised between the first and second estimate arrival times at the IAF and considering as time distance among the different arrival times at the IAF the time distance (DS) due to the wake turbulence of the preceding aircraft in the sequence of arrival times at the IAF or the airport receptivity (RA) in the case wherein said airport receptivity (RA) is larger than said time distance (DS), said method comprising successively:—Sending (F3) the defined arrival time at the IAF (OT1, OT2 . . . 0Tn) for each single aircraft which is defined by said second device with the definition of the defined sequence of arrival times at the IAF to each first device of the single aircraft of the plurality of aircrafts for the arrival at the IAF of the aircraft in said defined arrival time at the IAF.

The present invention relates to a method for generating a sequence of arrival times at the IAF of aircrafts due to arrive at a specific airport.

Air traffic has been significantly increasing for several years and so have the number of landings and take-offs and the amount of ground traffic at the airports themselves. Furthermore, a significant increase in the number of vehicles providing ground support to aircraft (both cargo and passenger) has been observed; i.e., an increase in the infrastructures which provide catering or cleaning services, as well as aircraft maintenance and support services, etc. It is known that a series of operations are carried out immediately after an aircraft has landed, such as parking and positioning, to disembark the passengers and/or cargo.

With this substantial and progressive increase in traffic on the ground and in the number of landings and take-offs, it is necessary to manage air traffic at airports in the best possible manner to maximize the number of take-offs and landings without affecting safety either on the ground or in the air. In other words, it is necessary to maximize the air traffic management capacity at each individual airport without compromising the safety of the individual airport.

One of the major limitations to such a capability is the wake turbulence of the aircraft which depends on the weight of the aircraft which is landing and the weight of the aircraft which must land successively.

For this reason, there is a take-off and landing sequence that all aircraft must respect to maximize the number of take-offs and landings and to ensure that said take-offs and landings take place in complete safety.

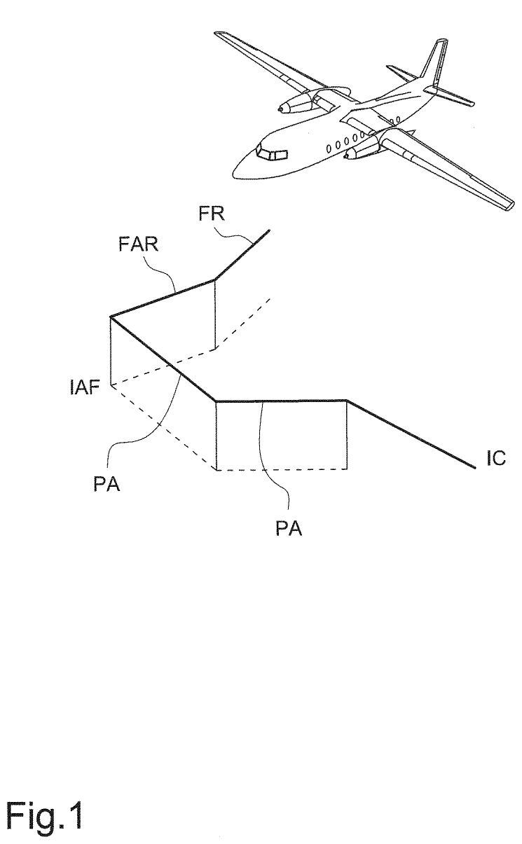

Currently, however, it is often the case that some aircraft, before starting the approach procedure PA to the airport IC where they must land (FIG. 1), i.e. before arriving at the IAF (Initial Approach Fix), passing in the flight phase from the route phase FR to the flight phase in which the arrival segment FAR is followed, are made to wait in the air, thus creating the so-called holding pattern. When the aircraft arrives at the IAF, it is no longer possible to make it hold at altitude; its altitude is very low and holding is very costly in terms of fuel consumption.

In view of the stat of the art, it is the object of the present invention to provide a method for automatically generating a sequence of arrival times at the IAF of aircraft which are due to arrive at a specific airport which makes it possible to minimize the holding times for the arrival at the IAF of the aircraft to an airport and thereby the fuel consumption of the aircraft.

According to the present invention, said object is achieved by means of a method of generating a sequence of arrival times at the IAF of a plurality of aircrafts which must arrive at a specific airport, said method comprising:
Establishing at least a first and a second estimate arrival times at the IAF as a function of the minimum and the maximum cruise speed of each aircraft and also as a function of the cruise altitude and the descendant angle of the aircraft by means of a first device belonging to each aircraft of the plurality of aircraft;
Sending said first and second estimate arrival times at the IAF of each aircraft from the first device of each aircraft of the plurality of aircraft to a second device arranged inside said specific airport when each aircraft of the plurality of aircraft is in flight towards the specific airport;
Defining a sequence of arrival times at the IAF for each single aircraft of said plurality of aircrafts as a function of said first and second estimate arrival times at the IAF and at least the wake turbulence data of each aircraft and the airport receptivity of said specific airport, said defining step comprising:
Extracting from a database said wake turbulence data of the plurality of aircrafts;
Grouping the aircrafts having the same wake turbulence category and the arrival time at the IAF of which is inside a time window comprised between the first and second estimate arrival times at the IAF and considering as time distance among the different arrival times at the IAF the time distance due to the wake turbulence of the preceding aircraft in the sequence of arrival times at the IAF or the airport receptivity in the case wherein said airport receptivity s larger than said time distance, said method comprising successively:
Sending the defined arrival time at the IAF for each single aircraft which is defined by said second device with the definition of the defined sequence of arrival times at the IAF to each first device of the single aircraft of the plurality of aircraft for the arrival at the IAF of the aircraft in said defined arrival time at the IAF.

Again according to the present invention, it is possible to provide generation system of a sequence of arrival times at the IAF of a plurality of aircrafts which must arrive at a specific airport as defined in claim 6.

By virtue of the present invention, it is possible to provide a method for generating a sequence of aircraft arrival times at the IAF which allows a decrease in fuel consumption by the aircraft using it (and thus a strong reduction in aircraft operating costs) because it avoids holding patterns.

By virtue of said method and system, it is always possible to modify the arrival sequence of the aircraft at the IAF in real-time if one or more aircraft delay their scheduled arrival due to various problems encountered during the flight. Indeed, the estimated arrival times at the IAF are sent from all aircraft when they are in flight and in the vicinity of the specific airport and not before the departure of the aircraft from the departure airport; in this manner, the sequence of arrival times at the IAF which is generated is more reliable than a sequence of times generated before the departure of the aircraft because it already comprises possible delays regarding departure from the departure airport and possible delays due to various problems encountered during the first part of the flight.

Said method makes it possible to dynamically modify the sequence of arrival times at the IAF for the plurality of aircraft already in flight with destination to a specific airport, by recalculating, assigning and re-transmitting the new arrival time at the IAF to each of them. This arrival time cannot be calculated and/or pre-arranged in any manner prior to departure; some examples, significant but not exhaustive, are:
Two or more aircraft, departing from the same airport but with different destinations, may have to depart at the same time to land at a pre-arranged time at different airports;
A flock of birds moves near the runway of the airport from which an aircraft is to depart with a pre-coordinated landing time at another airport: delay for deterrence operations;
The visibility value on the ground degrades; the aircraft maneuver at a significantly lower speed and the interval between successive approaches (for the destination airport of the plurality of aircraft) increases as does the average interval between successive take-offs (from another airport for the destination airport subject to IAF overflight time calculation);
The wind direction changes so that it is necessary to change the direction of landing and take-off; this operation implies a) in-flight holding and delays that can be compensated by flying at a lower speed; b) the use of a new IAF and therefore recalculated overflight times.

In all of these situations, recalculating and sending, by means of the described instruments, an updated and realistic revised arrival time at the IAF to the plurality of said aircraft directed to the specific airport becomes possible only by the method according to the invention.

Furthermore, by virtue of the present method, it is possible to increase the comfort of the passengers, because all the turns of the holding patterns which can annoy them when carried out at low altitudes are avoided and because the aircraft, when necessary, flies at lower speeds thus reducing the cabin noise.

With said method, there is also an increase in air navigation safety, because by eliminating (or almost eliminating) the number of aircraft which are normally present in the areas intended for holding in flight the aircraft for landing, it reduces the risk of loss of separation between aircraft.

Secondary benefits are given by the reduction of carbon dioxide (CO2) emissions both direct (the one emitted directly by the aircraft) and indirect (the one required for the whole chain of unused fuel), the continuous descent from cruise altitude to landing with engines at minimum power which implies the reduction of noise caused by the engines themselves when they are not at minimum power, the optimization of ground resources (means and personnel) for the better planning and management of parking areas.

The features and the advantages of the present invention will be apparent from the following detailed description of a practical embodiment thereof, illustrated by way of non-limiting example in the accompanying drawings, in which:

FIG. 1 diagrammatically shows the flight phases to the landing of an aircraft;

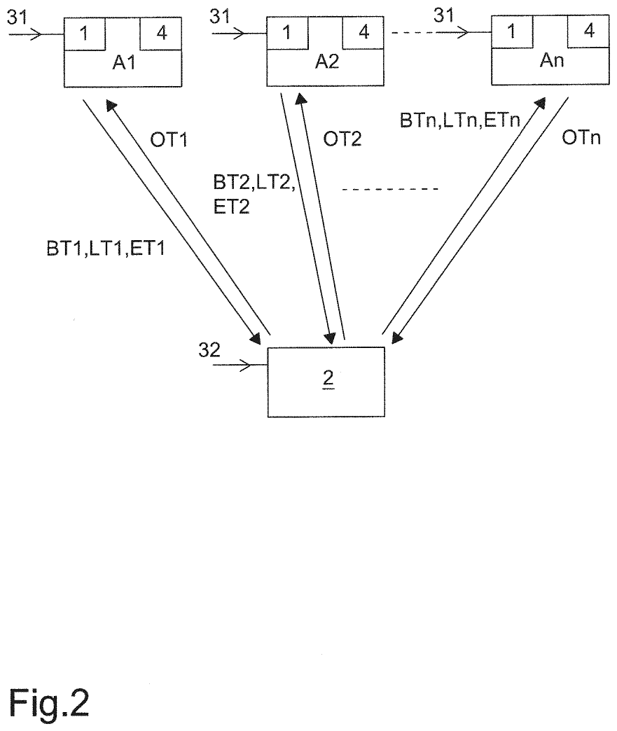

FIG. 2 shows the apparatus for generating a sequence of arrival times at the IAF of aircraft due to arrive at a specific airport according to the present invention;

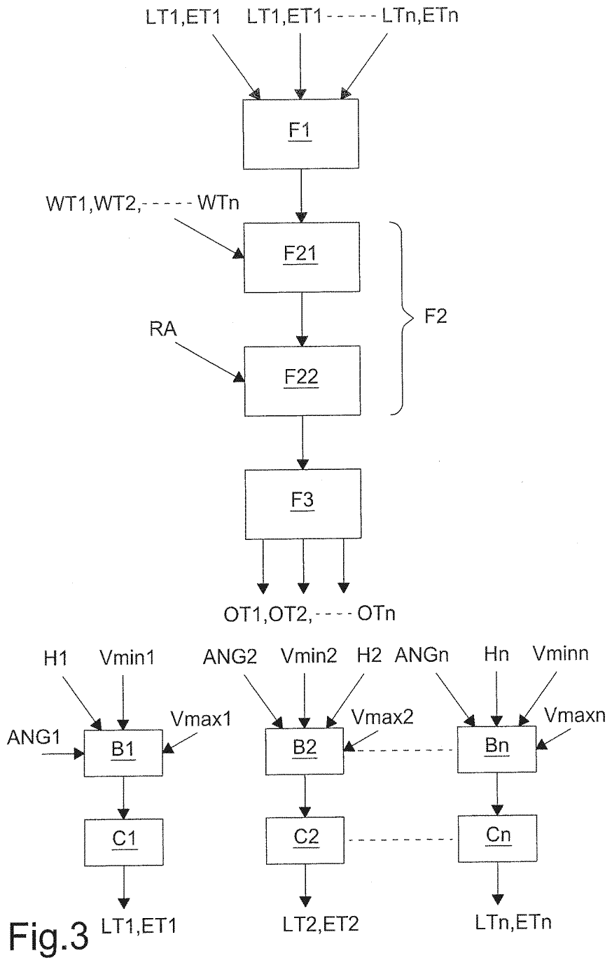

FIG. 3 shows the operation of the IFAM software according to an embodiment of the present invention;

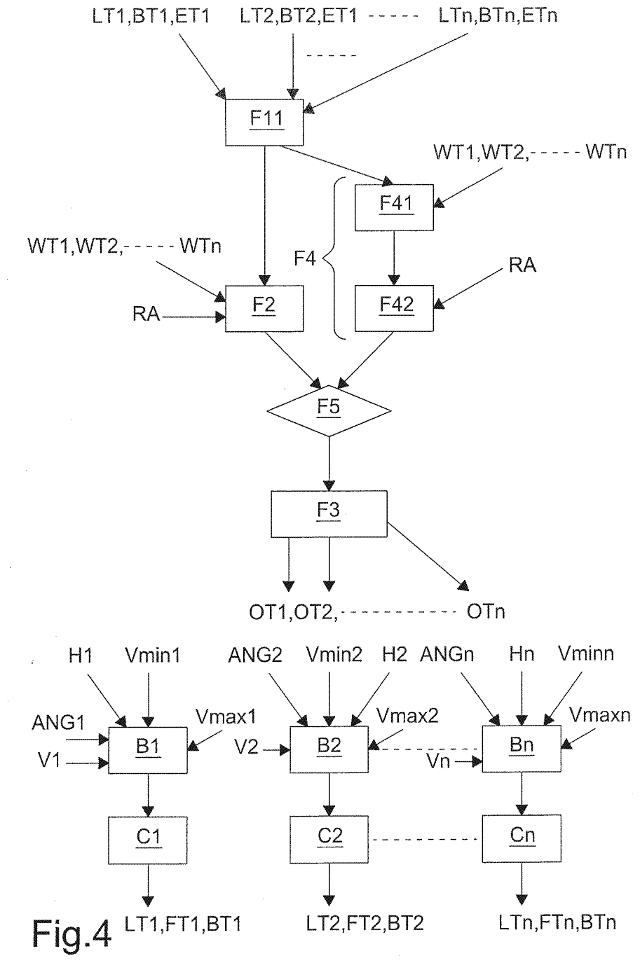

FIG. 4 shows the operating of the IFAM software according to a variant of the first embodiment of the present invention.

An apparatus for generating a sequence of arrival times at the IAF of aircraft due to arrive at a specific airport according to the present invention is shown in FIG. 2. IAF means the initial approach fix point, i.e., the end point of the flight phase of the arrival segment before the flight phases of the airport approach procedure. The apparatus comprises a first device 1 arranged on each aircraft and a second device 2 arranged at the airport where the aircraft is due to land. The devices 1 and 2 comprise a memory for storing data and for storing Ifam client executive software IFAM and a processor for processing the data and executing the software. Furthermore, the devices 1 and 2 comprise respective antennas 31, 32 for transmitting and receiving data between them.

The devices 1 and 2 may be dedicated devices but, for the most part, they are part of devices which already exist on aircraft and in airports, e.g., the device 1 may be part of an aircraft on-board computer and the device 2 may be part of the airport control tower central computer.

In particular, the software may be a dedicated application of the aircraft on-board computer and the airport control tower central computer. The antenna may be a radio frequency or satellite type antenna.

The device 1, if it is connected to or forms part of the aircraft computer, is preferably connected to a speed sensor 4 adapted to determine the cruise speed V1, V2 . . . Vn of the aircraft of a plurality of aircraft A1 . . . An due to arrive at a specific airport IC. The cruising altitude of the aircraft H1, H2 . . . Hn and the angle of descent ANG1, ANG2 . . . ANGn decided by the airline to which the aircraft belongs are used to form the estimated time of arrival of the aircraft at the IAF and belong to the databases D1 . . . Dn of the corresponding aircraft A1 . . . An.

The Ifam client application on the device 1 generates in phase B1, B2 . . . Bn two times, time ET1, ET2 . . . ETn processed considering the maximum cruise speed Vmax1, Vmax2 . . . Vmaxn of the aircraft and time LT1, LT2 . . . LTn processed considering the minimum cruise speed Vmin1, Vmin2 . . . Vminn of the aircraft (as shown in FIG. 3); the minimum speed values Vmin1, Vmin2 . . . Vminn and the maximum speed values Vmax1, Vmax2 . . . Vmaxn are fixed by the airline to which the aircraft belongs and belong to the databases D1 . . . Dn of the corresponding aircraft A1 . . . An. The Ifam client software residing in the memory of the device 1 preferably generates the estimated time BT1, BT2 . . . BTn on the arrival airport (as shown in FIG. 4 according to a variant of the embodiment of the invention) with the data V1, V2 . . . Vn, H1, H2 . . . Hn and ANG1, ANG2 . . . ANGn. For the respective times BT1, ET1, LT1 and BT2, LT2, ET2 . . . LTn, ETn, BTn, the values H1, H2 . . . Hn and ANG1, ANG2 . . . ANGn are the same while the speed varies.

If the device 1 is either not connected to or not part of the aircraft computer, the values V1, V2 . . . Vn, H1, H2 . . . Hn and ANG1, ANG2 . . . ANGn, Vmax1, Vmax2 . . . Vmaxn, Vmin1, Vmin2 . . . Vminn are manually entered by a user into the device 1.

The time values are sent in step C1, C2 . . . Cn from each aircraft of the plurality of aircraft A1 . . . An arriving at a specific airport IC via the antenna 31 to the device 2 located at the airport IC, i.e., when each aircraft of the plurality of aircraft A1 . . . An is in flight towards the specific airport IC, in particular when each aircraft of the plurality of aircraft A1 . . . An is at a time distance Twindow from arrival at the IAF between 25 or 30 minutes and 50 minutes.

Therefore, the times ET1, LT1, LT2, ET2 . . . LTn, ETn are sent from the plurality of aircraft A1 . . . An towards the device 2 located at the specific arrival airport, as shown in FIG. 3; preferably, according to a variant of the embodiment of the invention shown in FIG. 4, the times BT1, ET1, LT1, BT2, LT2, ET2 . . . BTn, LTn, ETn are sent from the plurality of aircraft A1 . . . An towards the device 2 located at the specific arrival airport.

The IFAM software residing in the memory of the airport device 2 must process the best arrival sequence of the aircraft of the plurality of aircraft A1 . . . An as a function of given values, such as the arrival time values received from each aircraft of the plurality of aircraft A1 . . . An through the antenna 32 and at least one further parameter given by the wake turbulence data WT1, WT2 . . . WTn of each aircraft of the plurality of aircraft A1 . . . An.

Preferably, the IFAM software processes said sequence of arrival of the aircraft of the plurality of aircraft A1 . . . An as a function also of other parameters which are entered directly by a user into the device 2 because said device 2 has the possibility of receiving data from the outside also in other manners besides the antenna 32, e.g. by typing in said data through a keyboard or by connecting to databases present in the central computer of the airport in which data DP concerning the airport runways, data PP on the parking aprons, or other technical data on the aircraft of said plurality of aircraft A1, A2 . . . An are entered.

The wake turbulence WT of an aircraft consists of the vortices which are generated by the wings when they generate lift. The landing and take-off configuration, with extended flaps and slats, amplifies this effect. For wake turbulence purposes, aircraft are divided into four categories according to their maximum take-off weight MTOW: L (light) with MTOW<=7,000 kg, M (medium) with 7,000 kg<=MTOW<=136,000 kg, H (heavy) with MTOW>136,000 kg and J (super) for AirBus A380 and Antonov A225.

The separation or spacing between successive approaches in distance and time is a function of the leading and trailing aircraft pair, as shown in the following table in which the distance spacing DS (in miles NM) and the time spacing DT (in minutes Min) of the aircraft pair (trailing aircraft, leading aircraft) having wake category J, H, M, L are shown.

| Wake category | DS (NM) | DT (Min) |
|---|---|---|
| J after J | 4 | 1′30″ |
| H after J | 5 | 2 |
| M after J | 7 | 3 |
| L after J | 8 | 4 |
| H after H | 4 | 2 |
| M after H | 5 | 2′30″ |
| L after H | 6 | 4 |
| M after M | 3 | Not required |
| L after M | 5 | 2′30″ |

Preferably a database DWT present in the memory of the device 2 comprises WT1, WT2 . . . WTn data comprising the indication of the wake turbulence category of the aircraft A1 . . . An and the elements of the aforesaid table. The capacity, in time, of airports to accept successive landings or airport receptivity RA is established by the Competent Aviation Authority. It is a characteristic value for each airport and depends on the number of runways and the manner in which they are used, the airport layout, the type of critical aircraft (i.e. the largest aircraft that can operate at that airport), the concurrence of departing aircraft.

Currently, the sequence of arrival at the IAF of a plurality of aircraft due to arrive at a specific airport does not follow any specific rules except that the aircraft arriving first begins the approach and landing procedure and the others follow. Therefore, a sequence of arrival at the IAF of 14 aircraft of different wake turbulence category at an airport with receptivity, i.e. the time period between successive aircraft landings, of two minutes could be as shown in the following table in which the number in the sequence, the wake category, the distance in time to the following aircraft are indicated in each cell, resulting in a total time of 32 minutes.

| 1. M | 2. J | 3. M | 4. M | 5. H | 6. M | 7. H | 8. M | 9. H | 10. J | 11. M | 12. H | 13. M | 14. M | 15. M |
|---|---|---|---|---|---|---|---|---|---|---|---|---|---|---|
| 2′ | 3′ | 2′ | 2′ | 2′30″ | 2′ | 2′30″ | 2′ | 2′30″ | 3′ | 2′ | 2′30″ | 2′ | 2′ | |

The method according to the invention optimizes the sequence of arrival times at the IAF of aircraft. Considering the value of the distance in time due to wake turbulence, it is possible to optimize the sequence of arrival times at the IAF of aircraft only for airports that have a receptivity of two minutes or less.

The method according to the invention operates on the plurality of aircraft A1 . . . An which are in flight towards the specific airport and are due to arrive at the specific airport IC, and comprises a step of processing a sequence BS of arrival times at the IAF of the plurality of aircraft A1 . . . An arriving at the specific airport IC, as shown in FIG. 4.

After step F1 of receiving the ET1, ET2 . . . ETn and LT1, LT2 . . . LTn values of the plurality of aircraft A1, A2 . . . An, the BS sequence of arrival times at the IAF is processed in step F2 considering the WT1, WT2 . . . WTn data regarding the wake turbulence category of the plurality of aircraft A1, . . . An and the data received in step F1; the data WT1, WT2 . . . WTn are extrapolated from a database DWT in the memory of the device 2. Therefore, the phase F2 comprises a step F21 of extrapolating from the database DWT the data WT1, WT2 . . . WTn and the step F22 in which the aircraft of the plurality of aircraft A1 . . . An having the same wake turbulence category are grouped together and the arrival time at the IAF of each individual aircraft is made to be within the time window given by the LT and ET values of the individual aircraft of the plurality of aircraft A1 . . . An, i.e., the time windows LT1-ET1, LT2-ET2, . . . LTn-ETn, and considering as the time spacing between the various arrival times at the IAF either the time spacing DS due to wake turbulence of the aircraft preceding in the sequence of arrival times at the IAF or the airport receptivity RA if RA is greater than DS. This sequence of arrival times at the IAF makes it possible to alter the speed of the aircraft to avoid holding and allows runway occupancy optimization; at airports characterized by a mix of aircraft with different wake turbulence categories, more aircraft land in the same time interval.

For example, considering an airport having an airport receptivity RA equal to two minutes, the method according to the invention makes it possible to obtain an improved sequence of arrival times at IAF BS obtaining a total time T1 of 28 minutes and 30 seconds:

| 1. M | 3. M | 4. M | 2. J | 10. J | 4. H | 5. H | 7. H | 9. H | 6. M | 8. M | 11. M | 13. M | 14. M | 15. M |
|---|---|---|---|---|---|---|---|---|---|---|---|---|---|---|
| 2′ | 2′ | 2′ | 2′ | 2′ | 2′ | 2′ | 2′ | 2′30″ | 2′ | 2′ | 2′ | 2′ | 2′ | |

Instead, considering an airport having an airport receptivity RA lower than two minutes, e.g. 1 minute and 30 seconds, the method according to the invention makes it possible to obtain an improved sequence of arrival times at IAF BS obtaining a total time T1 of 23 minutes and 30 seconds:

| 1. M | 3. M | 4. M | 2. J | 10. J | 5. H | 7. H | 9. H | 12. H | 6. M | 8. M | 11. M | 13. M | 14. M | 15. M |
|---|---|---|---|---|---|---|---|---|---|---|---|---|---|---|
| 1′30″ | 1′30″ | 1′30″ | 1′30″ | 1′30″ | 2′ | 2′ | 2′ | 2′30″ | 1′30″ | 1′30″ | 1′30″ | 1′30″ | 1′30″ | |

The method according to the invention comprises, after the step F2 of processing the sequence of arrival times at IAF BS, a step F3 wherein the arrival times at IAF OT1 . . . OTn of the sequence of times BS is sent to the aircraft of the plurality of aircraft A1 . . . An. The steps F1, F21, F22 and F3 are IFAM software functions of the second device 2 arranged at the airport IC and belonging to the system of generating a sequence of arrival times at IAF OT1, OT2 . . . OTn of a plurality of aircraft A1, A2 . . . An due to arrive at a specific airport IC according to an embodiment of the invention.

Preferably, according to a variant embodiment of the present invention shown in FIG. 4, the method according to the invention operates on the plurality of aircraft A1 . . . An located in the vicinity of the specific airport IC, i.e., on the plurality of aircraft A1 . . . An which are in flight towards the specific airport IC, and comprises a step of simultaneously processing of the sequence BS and another sequence NS of arrival times at the IAF of the plurality of aircraft A1 . . . An arriving at the specific airport IC.

After step F11 of receiving the values ET1, ET2 . . . ETn, LT1, LT2 . . . LTn and BT1, BT2 . . . BTn of the plurality of aircraft A1, A2 . . . An, the sequence NS of arrival times at the IAF is processed in step F4 considering the data WT1, WT2 . . . WTn regarding the wake turbulence category of the plurality of aircraft A1 . . . An and the data received in step F1. The step F4 thus comprises a step F41 of extracting the data WT1, WT2 . . . WTn from the database DWT and the step F42 of processing the sequence NS based on the time BT sent from each aircraft of the plurality of aircraft A1 . . . An, i.e., the values BT1, BT2 . . . BTn, and considering as time spacing between the various arrival times at the IAF either the time spacing DS due to the wake turbulence category of the aircraft preceding in the sequence of arrival times at the IAF or the airport receptivity RA if RA is greater than DS.

The sequence BS of arrival times to the IAF is processed in step F2 in parallel and at the same time as step F4, grouping the aircraft of the plurality of aircraft A1 . . . An having the same wake turbulence category and so that arrival time at the IAF of each individual aircraft is made to be within the time window given by the LT and ET values of the individual aircraft of the plurality of aircraft A1 . . . An, i.e., the time windows LT1-ET1, LT2-ET2, . . . LTn-ETn, and considering as the time spacing between the various arrival times at the IAF either the time spacing DS due to wake turbulence of the aircraft preceding in the sequence of arrival times at the IAF or the airport receptivity RA if RA is greater than DS. The latter sequence of arrival times at the IAF makes it possible to alter the speed of the aircraft to avoid holding and allows runway occupancy optimization; at airports characterized by a mix of aircraft with different wake turbulence categories, more aircraft land in the same time interval.

The method according to the invention comprises, after the step of processing the arrival time sequences at the IAF NS and BS, a step of selecting the arrival time sequence at the IAF to be used. Said step of selecting comprises a step of comparing the total time period T1 of the arrival time sequence at IAF BS and the total time period T2 of the second arrival time sequence at the IAF NS. If the difference between T2 and T1 is either less than or equal to the airport receptivity RA, the method chooses to use the second sequence of arrival times at the IAF NS otherwise the BS sequence is chosen.

After the step of choosing, the arrival times at IAF OT1 . . . OTn of the sequence of times that has been chosen is sent to the aircraft of the plurality of aircraft A1 . . . An in step F3.

Preferably, other data, such as data DP concerning airport runways, data PP on parking aprons, or other technical data on aircraft of said plurality of aircraft A1, A2 . . . An, are taken into account in processing steps F2 and F4. All of these data combine to define the arrival time sequences at IAF BS and NS.

The arrival times at the IAF OT1 . . . OTn are sent from the device 2 located at the airport to the devices 1 of the individual aircraft of the plurality of aircraft A1, A2 . . . An at least within a predetermined time period TP, of e.g. 90 minutes, before the first arrival time at the IAF. The steps F11, F2, F41, F42, F5 and F3 are IFAM software functions of the second device 2 arranged at the airport IC and belonging to the system of generating a sequence of arrival times at IAF OT1, OT2 . . . OTn of a plurality of aircraft A1, A2 . . . An due to arrive at a specific airport IC according to a variant of the embodiment of the invention.

The sequence of arrival times at the IAF can be updated if an aircraft A0 not belonging to the plurality of aircraft A1, A2 . . . An is more than the predetermined TC time period, e.g. 25 or 30 minutes, from arrival at the IAF at the IC airport. In this case, there is a new processing of the sequences BS, NS in the steps F2, F4 considering also said aircraft A0, and the arrival times to the IAF OT0, OT1 . . . OTn are sent to the aircraft of the plurality of aircraft A0, A1, A2 . . . An. In particular, if another aircraft A0 not belonging to the plurality of aircraft A1, A2 . . . An is arriving on said specific IC airport, after the step of sending the arrival time to the IAF defined for each individual aircraft by the second device, the method returns to the step of defining the sequence BS, NS of arrival times to the IAF to define an updated sequence BS, NS of arrival times to the IAF also considering the estimated arrival times LT0, ET0 and preferably BT0 of said other aircraft A0 to have an updated plurality of aircraft A0, A1, A2 . . . An located in the vicinity of the specific IC airport, i.e., an updated plurality of aircraft A0, A1 . . . An which is in flight towards the specific airport IC. The updated arrival time at the IAF OT0, OT1, OT2 . . . OTn defined for each individual aircraft is sent from said second device 2 with the definition of the updated sequence of arrival times at the IAF to each first device of the individual aircraft of the plurality of aircraft for the arrival at the IAF of the aircraft in said updated arrival time at the IAF.

It is also possible to update the sequence of arrival times at the IAF if an aircraft cannot respect the scheduled arrival time at the IAF due to the presence of turbulence, a longer route to avoid bad weather, etc.; the update of the sequence of arrival times at the IAF takes place in real-time. In this case, there is a new processing of the sequences BS, NS in the steps F2 and F4 and the new arrival times to the IAF OT1 . . . OTn are sent to the aircraft of the plurality of aircraft A1, A2 . . . An.

Preferably, it is not possible to update the sequence of arrival times at the IAF if an aircraft of the plurality of aircraft A0, A1, A2 . . . An is within the predetermined time period TC from its defined time of arrival at the IAF OT0, OT1 . . . OTn.

1. A generation method of a sequence of arrival times at the Initial Approach Fix (IAF) of a plurality of aircrafts which must arrive at a specific airport, said method comprising:
establishing at least one first and a second estimate arrival times at the IAF as a function of a minimum and a maximum cruise speed of each aircraft and as a function of a cruise altitude and the a descendent angle of the aircraft by a first device arranged inside each aircraft of the plurality of aircrafts;
sending said first and second estimate arrival times at the IAF of each aircraft from the first device arranged inside each aircraft of the plurality of aircrafts to a second device arranged inside said specific airport when each aircraft of the plurality of aircrafts is in flight towards the specific airport;
defining a sequence of arrival times at the IAF for each single aircraft of said plurality of aircrafts as a function of said first and second estimate arrival times at the IAF and at least wake turbulence data of each aircraft and an airport receptivity of said specific airport, said defining step comprising:
extracting from a database said wake turbulence data of the plurality of aircrafts; and
grouping the aircrafts having the same wake turbulence category and the arrival time at the IAF of which is inside a time window comprised between the first and second estimate arrival times at the IAF and considering as time distance among the different arrival times at the IAF the time distance due to the wake turbulence of a preceding aircraft in the sequence of arrival times at the IAF or the airport receptivity in the case wherein said airport receptivity is larger than said time distance, said method comprising successively:
sending the defined arrival time at the IAF for each single aircraft which is defined by said second device with the definition of the defined sequence of arrival times at the IAF to each first device of the single aircraft of the plurality of aircrafts for the arrival at the IAF of the aircraft in said defined arrival time at the IAF.

2. The method according to claim 1, wherein said step of establishing a first and second estimate arrival times at the IAF comprises establishing a third estimate arrival time at the IAF as a function of the cruise speed of each aircraft and as a function of the cruise altitude and the descendent angle of the aircraft, said sending step comprising sending said third estimate arrival time at the IAF of each aircraft from the first device arranged inside each aircraft of the plurality of aircrafts to the second device arranged inside said specific airport, said method further comprising:
further defining a further sequence of arrival times at the IAF for each single aircraft of said plurality of aircrafts as a function of said third estimate arrival time at the IAF and at least the wake turbulence data of each aircraft and the airport receptivity of said specific airport, said further defining step being effectuated simultaneously to the defining step and comprising:
extracting from a database said wake turbulence data of the plurality of aircrafts;
processing a further sequence on the base of said third estimate arrival time at the IAF which is sent from each aircraft of the plurality of aircrafts and considering as time distance among the different arrival times at the IAF the time distance due to the wake turbulence of the preceding aircraft in the sequence of arrival times at the IAF or the airport receptivity in the case wherein said airport receptivity is larger than said time distance, said method comprising successively:
Selecting the sequence of arrival times at the IAF which should be used between said defined sequence of arrival times at the IAF and said further defined sequence of arrival times at the IAF, said selecting step being effectuated by comparing a further entire time period (T1) of said defined sequence and the an entire time period (T2) of said further defined sequence and verifying if the difference between said further entire time period and the entire time period is lower or greater than the airport receptivity value of said specific airport so as to select respectively said further defined sequence of arrival times at the IAF or said defined sequence of arrival times at the IAF, and
sending the defined arrival time at the IAF for each single aircraft which is defined by said second device with the selected sequence of arrival times at the IAF to each first device of the single aircraft of the plurality of aircrafts for the arrival at the IAF of the aircraft in said defined arrival time at the IAF.

3. The method according to claim 1, wherein if an aircraft cannot meet the defined time arrival at the IAF, back to the defining the sequence of arrival times at the IAF to define an updated sequence of arrival times at the IAF, successively sending the defined arrival time at the IAF for each single aircraft which is defined by said second device with the updated sequence of arrival times at the IAF to each first device of the single aircraft of the plurality of aircrafts for the arrival at the IAF of the aircraft in said updated arrival time at the LAF.

4. The method according to claim 1, wherein if another aircraft which does not belong to the plurality of aircrafts must arrive on the specific airport after sending the defined arrival time at the IAF for each single aircraft which is defined by said second device, back to the defining the sequence of arrival times at the IAF to define an updated sequence of arrival times at the IAF considering said another aircraft so as to obtain an updated plurality of aircrafts that must arrive on the specific airport, successively sending the updated arrival time at the IAF for each single aircraft which is defined by said second device with the updated sequence of arrival times at the IAF to each first device of the single aircraft of the updated plurality of aircrafts for the arrival at the IAF of the aircraft in said updated arrival time at the IAF.

5. The method according to claim 3, wherein the updating of the defined arrival time at the IAF which is defined to each single aircraft from said second device cannot occur inside a prefixed time period (TC) before the defined arrival time at the IAF.

6. A generation system of a sequence of arrival times at the IAF of a plurality of aircrafts which must arrive at a specific airport, said system comprising a first device, provided with a data processing means and a memory means wherein a first executing software (Ifam client) is installed, arranged inside each aircraft of said plurality of aircrafts and a second device, provided with a data processing means and a memory means wherein a second executing software is installed, arranged inside said airport, said second device being in a wireless communication with the first device, said first software comprising the functions of:
establishing at least one first and a second estimate arrival times at the IAF as a function of a minimum and a maximum cruise speed of each aircraft and as a function of the cruise altitude and the descendent angle of the aircraft by means of a first device arranged inside each aircraft of the plurality of aircrafts;
sending said first and second estimate arrival times at the IAF of each aircraft from the first device arranged inside each aircraft of the plurality of aircrafts to a second device arranged inside said specific airport when each aircraft of the plurality of aircrafts is in flight towards the specific airport, said second software comprising the functions of
defining a sequence of arrival times at the IAF for each single aircraft of said plurality of aircrafts as a function of said first and second estimate arrival times at the IAF and at least the wake turbulence data of each aircraft and the airport receptivity of said specific airport, said defining function comprising:
extracting from a database said wake turbulence data of the plurality of aircrafts; and
grouping the aircrafts having the same wake turbulence category and the arrival time at the IAF of which is inside a time window comprised between the first and second estimate arrival times at the IAF and considering as time distance among the different arrival times at the IAF the time distance due to the wake turbulence of the preceding aircraft in the sequence of arrival times at the IAF or the airport receptivity in the case wherein said airport receptivity is larger than said time distance, said second software comprising successively the function of:
sending the defined arrival time at the IAF for each single aircraft which is defined by said second device with the definition of the defined sequence of arrival times at the IAF to each first device of the single aircraft of the plurality of aircrafts for the arrival at the IAF of the aircraft in said defined arrival time at the IAF.

7. The system according to claim 6, wherein said function of establishing a first and second estimate arrival times at the IAF comprises establishing a third estimate arrival time at the IAF as a function of the cruise speed of each aircraft and as a function of the cruise altitude and the descendent angle of the aircraft, said sending step comprising sending said third estimate arrival time at the IAF of each aircraft from the first device arranged inside each aircraft of the plurality of aircrafts to the second device arranged inside said specific airport, said second software comprising the functions of:
further defining a further sequence of arrival times at the IAF for each single aircraft of said plurality of aircrafts as a function of said third estimate arrival time at the IAF and at least the wake turbulence data of each aircraft and the airport receptivity) of said specific airport, said further defining function being effectuated simultaneously to the defining function and comprising:
extracting from a database said wake turbulence data of the plurality of aircrafts;
processing a further sequence on the base of said third estimate arrival time at the IAF which is sent from each aircraft of the plurality of aircrafts and considering as time distance among the different arrival times at the IAF the time distance due to the wake turbulence of the preceding aircraft in the sequence of arrival times at the IAF or the airport receptivity in the case wherein said airport receptivity is larger than said time distance, said second software comprising successively the functions of:
selecting the sequence of arrival times at the IAF which should be used between said defined sequence of arrival times at the IAF and said further defined sequence of arrival times at the IAF, said selecting step being effectuated by comparing the further entire time period (T1) of said defined sequence and the entire time period (T2) of said further defined sequence and verifying if the difference between said further entire time period and the entire time period is lower or greater than the airport receptivity value of said specific airport so as to select respectively said further defined sequence of arrival times at the IAF or said defined sequence of arrival times at the IAF, and
sending the defined arrival time at the IAF for each single aircraft which is defined by said second device with the selected sequence of arrival times at the IAF to each first device of the single aircraft of the plurality of aircrafts for the arrival at the IAF of the aircraft in said defined arrival time at the IAF.

8. The system according to claim 6, wherein if an aircraft cannot meet the defined time arrival at the IAF, the second software comprises going back to the function of defining the sequence of arrival times at the IAF to define an updated sequence of arrival times at the IAF, successively sending the defined arrival time at the IAF for each single aircraft which is defined by said second device with the updated sequence of arrival times at the IAF to each first device of the single aircraft of the plurality of aircrafts for the arrival at the IAF of the aircraft in said updated arrival time at the IAF.

9. The system according to claim 6, wherein if another aircraft which does not belong to the plurality of aircrafts must arrive on the specific airport after sending the defined arrival times at the IAF for each single aircraft which is defined by said second device, the second software comprises going back to the function of defining the sequence of arrival times at the IAF to define an updated sequence of arrival times at the IAF considering said another aircraft so as to obtain an updated plurality of aircrafts that must arrive on the specific airport, successively sending the updated arrival time at the IAF for each single aircraft which is defined by said second device with the updated sequence of arrival times at the IAF to each first device of the single aircraft of the updated plurality of aircrafts for the arrival at the IAF of the aircraft in said updated arrival time at the IAF.

10. The system according to claim 6, wherein each first device belong or is electrically connected to the on board computer of the aircraft of the plurality of aircraft and it receives from said on board computer the data on the cruise speed of each aircraft, the cruise altitude and the descendent angle of the aircraft so as to automatically generate said estimate arrival times at the IAF of the aircraft.
